(19) United States
(12) Patent Application Publication
(10) Pub. No.: US 2021/0034080 A1
(43) Pub. Date: Feb. 4, 2021

(54) DOSING MODULE HAVING A TEMPERATURE-CONTROLLABLE DOSING DEVICE, AND METHOD FOR CONTROLLING THE TEMPERATURE OF A DOSING DEVICE

(71) Applicant: Bayer Aktiengesellschaft, Leverkusen (DE)

(72) Inventors: Dietmar GUENTHER, Hueckeswagen (DE); Christoph FLEISCHER-TREBES, Essen (DE); Mike NIESEN, Koeln (DE)

(21) Appl. No.: 16/964,358

(22) PCT Filed: Jan. 24, 2019
(86) PCT No.: PCT/EP2019/051705

§ 371 Date: Jul. 23, 2020

(30) Foreign Application Priority Data
Jan. 25, 2018 (EP) 18153425.6

(51) Int. Cl. G05D 7/06; F28D 9/00; F28F 3/00; G01N 1/14

(52) U.S. Cl. CPC G05D 7/0617; F28D 9/00; F28D 2021/0078; G01N 1/14; F28F 3/00

(57) ABSTRACT

The invention relates to a metering module (10), in particular for a process plant having a modular construction, having a metering system (24) for metering a fluid, a housing (32) which at least partly accommodates the metering system (24) and also a temperature control device for controlling the temperature of the interior of the housing (32), wherein the temperature control device has a plate heat exchanger (34) and at least a part of the housing (32) is formed by at least one plate structure (36) of this plate heat exchanger (34), in particular by at least one so-called heat exchanger plate. The invention also relates to a process plant having a modular construction for the production of a chemical and/or pharmaceutical product having such a metering module (10) and to a method for controlling the temperature of a metering device (24) for metering liquids.

The invention relates to a metering module, in particular for a process plant having a modular construction, having a metering system for metering a fluid, a housing which at least partly accommodates the metering system and also a temperature control device for controlling the temperature of the interior of the housing.

The invention further relates to a process plant having a modular construction for the production of a chemical and/or pharmaceutical product, having one or more such metering modules and also to a method for controlling the temperature of a metering device for metering liquids.

The document WO 2007/057432 A1 discloses a sampler for automatically taking liquid samples from a sampling position. This sampler comprises (i) a sampling unit having a metering device, (ii) a sample collection unit for storing samples which have been taken, (iii) a housing which accommodates the sampling unit and also the sample collection unit, and also (iv) a temperature control unit for controlling the temperature of components of the sampler in the interior of the housing.

For the purposes of the present invention, the expression “controlling the temperature” should be interpreted as “bringing something to a particular temperature”. This can occur by heating or cooling depending on intended value and actual value of the temperature. The controlling of the temperature can, for example, occur by means of a temperature control device and/or a separate, external temperature control apparatus, with the temperature of the temperature control device and/or the temperature control apparatus to be imparted being imparted to the metering system by a temperature control medium present in a circuit with the metering system.

It is an object of the invention to provide measures which make it possible to meter fluids having temperatures different from ambient temperature very effectively.

The object is achieved according to the invention by the features of the independent claims. Preferred embodiments of the invention are indicated in the dependent claims, which can each, either in themselves or in any combination with one another, represent an aspect of the invention.

In the metering module of the invention for metering a fluid, having a metering system, a housing which at least partly accommodates the metering system and also a temperature control device for controlling the temperature of the interior of the housing, the temperature control device has a plate heat exchanger and at least a part of the housing is formed by at least one plate structure of this plate heat exchanger. This proposed temperature-controlled metering system with housing is a consequence of the idea of keeping the temperature of the system components whose temperatures are to be controlled as far as possible at temperature in the accommodated region and dispensing with temperature control of the individual components, where possible. This makes it possible to achieve a space-saving and modular construction which allows effective integration of different system components.

A plate heat exchanger (PHE), often also referred to as plate heat transferrer (PHT) or plate cooler (PC), is a specific type of construction of a heat exchanger having a plate structure, for example a stack of profiled plates, which are put together in such a way that the medium to be heated and the medium releasing heat flow in the alternating intermediate spaces.

To implement the invention, the HEP system (heat exchange plate system), for example from LOB GmbH, is advantageously used as plate heat exchanger. The plate structure of this HEP system is also referred to as heat exchanger plate. The principle of the HEP system is based on a metal sheet having a thickness of up to 2 mm being placed on a support sheet/support plate and joined by means of laser welding. The laser welding forms flow channels for the temperature control medium. After welding, these channels are widened by means of internal pressure, as a result of which uniform hollow spaces are formed. The temperature control medium can then be conveyed through these hollow spaces. In accordance with their method of production, these hollow spaces do not correspond in terms of cross section to flat geometric shapes such as polygons (triangle, rectangle, etc.) or circles. Accordingly, the channels of the heat exchanger plate are, for example, not tubes or pipes. This principle makes it possible to realize both holes and other recesses and also virtually any external contours of the HEP system (see also http://www.lob-gmbh.de/de/HEP-system/index.html#). The HEP system is also known by the names “Pillow Plate” and “Thermoblech”. The in-principle construction of the HEP system from LOB GmbH is described, inter alia, in the patent document DE 10 2006 029 821 B3.

The “fluid” or “process fluid” to be metered is generally a liquid, but can also be a liquid/gas mixture or be gaseous. The temperature to be attained by the temperature control is generally determined by the fluid to be metered. The fluid can, for example, be a liquid whose freezing point is above room temperature. In this case, it has to be heated to effect temperature control.

In some cases, it is unfavourable to control the temperature of the entire metering system, since the temperature prescribed by the fluid to be metered is unsuitable for parts of the metering system. In this case, the metering system is only partly enclosed, so that these parts of the metering system lie outside the temperature-controlled housing.

In a preferred embodiment of the invention, the metering system has a plurality of system components which are fluidically connected to one another via a piping system. One typical system component of the metering system is, for example, a (metering) pump. This is connected fluidically within the module via pipes of the piping system.

In a preferred embodiment of the invention, at least one system component of the metering system is fastened directly to the or at least one of the plate structures of the plate heat exchanger forming the part of the housing. In a preferred embodiment of the invention, at least one system component of the metering system is fastened directly to the or at least one of the heat exchanger plates forming the part of the housing.

Since the drive motors of conventional pumps are generally not designed for use at high temperatures, an arrangement of the pump such that the pump head is located in the temperature-controlled housing and the motor is arranged outside is proposed. In order to assist conduction of heat from the heat exchanger plate into the pump head, a particularly advantageous arrangement is attachment of the pump directly to the heat exchanger plate via the flange of the pump head.

If possible, control of the temperature of the metering system should be effected exclusively via the temperature-controlled housing. Merely for the sake of completeness, for example after rebuilding of the module, further temperature control measures are conceivable. For this purpose, it is then advantageous for at least a part of the pipes of the piping system to be configured as media-temperature-controllable (media-heatable) pipes and/or at least one of the system components to be media-temperature-controllable (media-heatable). The media-temperature-controllable pipes and/or system components can generally also be heated/cooled by means of an external temperature control apparatus. Corresponding media-heated pipes are known and are supplied, inter alia, as bundle pipes with accompanying steam heating by the supplier Swagelok. Media-heated pumps are likewise known. Thus, for example, the supplier Gather supplies a corresponding sleeve for heating pump heads. Corresponding pipes, sleeves, etc., can naturally also be used for cooling.

In a further preferred embodiment of the invention, the system components of the metering system comprise at least one of the following components: a (metering) pump, a filter, a shutoff valve, a pressure measuring device, a temperature measuring device, a flow meter and a relief valve. In a particularly preferred embodiment, all these system components are provided. The measuring devices, valves, etc., can naturally also be utilized for temperature control or regulation by means of the temperature control device and are in this case part of this device.

In a preferred embodiment of the invention, a plurality of system components of the metering system are fastened directly to the or at least one of the plate structures of the plate heat exchanger forming the part of the housing.

In a preferred embodiment of the invention, a plurality of system components of the metering system are fastened directly to the or at least one of the heat exchanger plates forming the part of the housing. In a particularly preferred embodiment of the invention, as many as possible of the system components of the metering system are fastened to the or at least one of the heat exchanger plates forming the part of the housing. In a further preferred embodiment of the invention, all system components of the metering system, with the exception of the pipes, are fastened to the or at least one of the heat exchanger plates forming the part of the housing. Holes for flanges, fasteners, etc., can be taken into account by appropriate positioning of the welding seams in the heat exchanger plate and the channels for the temperature control medium in the heat exchanger plate can be designed fluidically optimally and optimally in respect of heat transfer. The heat transfer in such a plate is in principle higher than that for, for example, a plate having fixed pipes.

The materials of the heat exchanger plate of the HEP system can be selected so that they are suitable and reliably useable for process plants for the production of a chemical and/or pharmaceutical product.

In the preferred embodiment of the invention described, the heat exchanger plates of the HEP system are used as supporting elements for the components of the modular metering system which are to be heated/cooled. Supporting elements here means that the heat exchanger plates hold system components and no further holders which would have to be connected to other housing parts are required.

To form the housing, the module comprises, in particular, the following further components in addition to the plate structure of the plate heat exchanger: a frame, housing parts and elements for thermal insulation (also referred to as heat insulation). The frame is preferably configured so that it can also support further module components outside the housing.

In particular, the module further comprises a pressure vessel for the process fluid and/or an electronics unit. The temperature of the pressure vessel can preferably be controllable, e.g. by means of an external temperature control apparatus. The process fluid is introduced from the pressure vessel into the system components of the metering system and then ultimately brought to temperature or, when the process fluid in the pressure vessel has been brought to the desired temperature, held at this temperature. The electronics unit here is, in particular, an electronics unit referred to as remote I/O controller, i.e. an instrument for remote access and switching over large distances via network connection (e.g. Ethernet or Internet connection). The temperature control device is, inter alia, controlled or regulated by means of this electronics unit. The electronics unit preferably controls or regulates the supply of the temperature medium from the external temperature control apparatus to the temperature control device.

In the process plant according to the invention having a modular construction for the production of a chemical and/or pharmaceutical product having a plurality of modules, at least one of these modules is configured as abovementioned metering module. The modules have, in particular, fixed, predetermined dimensions matched to one another.

The invention further provides a method for controlling the temperature of a metering system for metering fluids within a metering module, comprising the steps: a) provision of a metering module comprising a metering system which is at least partly accommodated by a housing, where at least part of the housing is formed by at least one plate structure of a plate heat exchanger which controls the temperature of the interior of the housing; b) provision of a temperature control medium for controlling the temperature of the plate heat exchanger, which medium is present in a circuit with the metering system; c) heating/cooling of the temperature control medium. The plate heat exchanger comprises hollow spaces or flow channels through which the temperature control medium is conveyed, by which means the interior of the housing and thus the metering system can be brought to or maintained at temperature. The plate structure of the plate heat exchanger is preferably a heat exchanger plate. The temperature control is preferably effected via a temperature control device and an external temperature controlled apparatus.

A preferred embodiment of the method of the invention comprises the steps: a) provision of a metering module comprising a metering system which is at least partly accommodated by a housing, where at least part of the housing is formed by at least one heat exchanger plate of a plate heat exchanger which controls the temperature of the interior of the housing; b) provision of a temperature control medium for controlling the temperature of the plate heat exchanger, which medium is present in a circuit with the metering system; c) heating/cooling of the temperature control medium by means of an external temperature control apparatus.

When the dimensions of the plate heat exchanger which controls the temperature of the housing, the insulation, the other temperature-relevant components and parameters and also the desired and expected temperatures are known, the heat requirement can be calculated in the design phase of the system.

Preferred embodiments of the method of the invention can be derived analogously to the abovementioned measures in respect of the metering module.

The invention will be illustrated by way of example below with reference to the accompanying figures and with the aid of preferred working examples, with the features presented below being able, both in themselves and also in combination with one another, to represent an aspect of the invention. The figures show

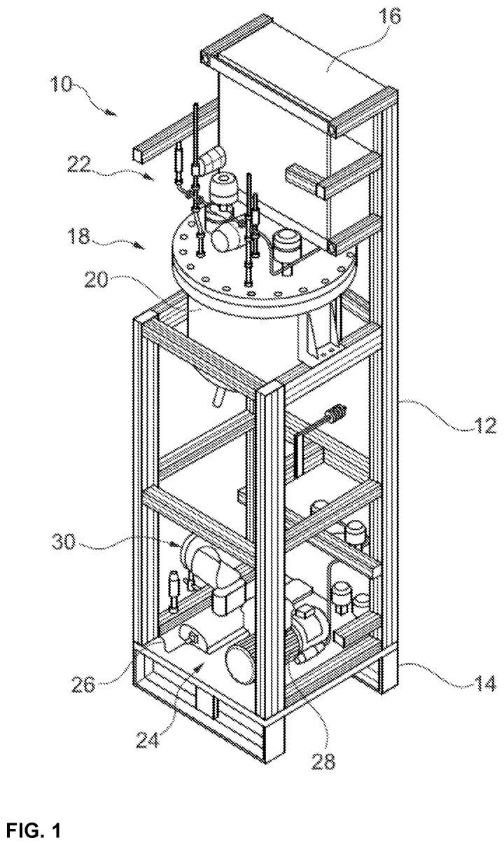

FIG. 1: a schematic depiction of components of a metering module of the invention according to a preferred embodiment of the invention,

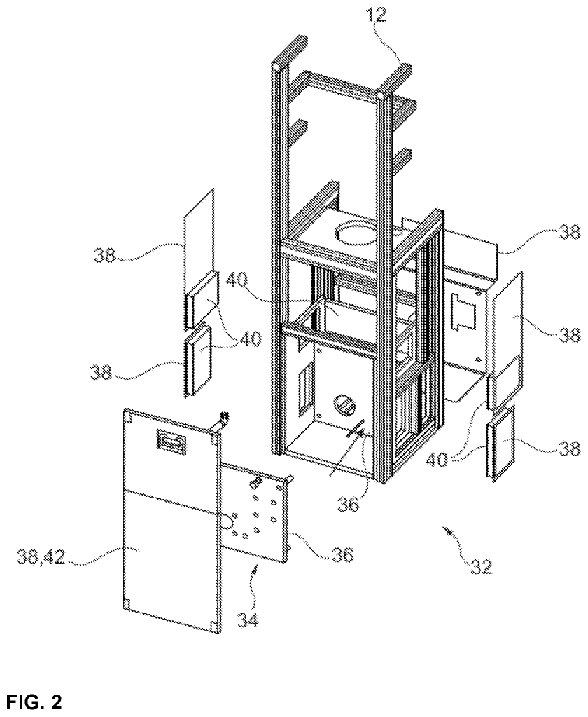

FIG. 2: the components of a housing for the metering module shown in FIG. 1,

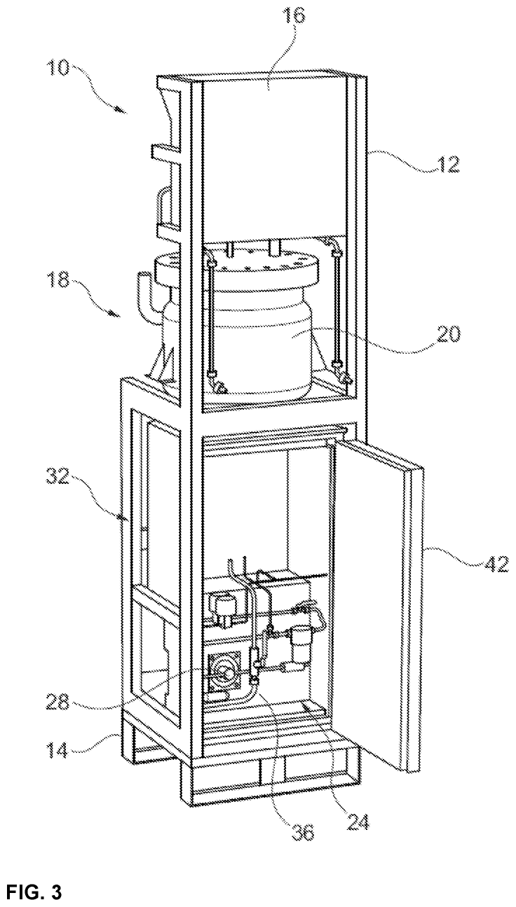

FIG. 3: the complete metering module in front view and

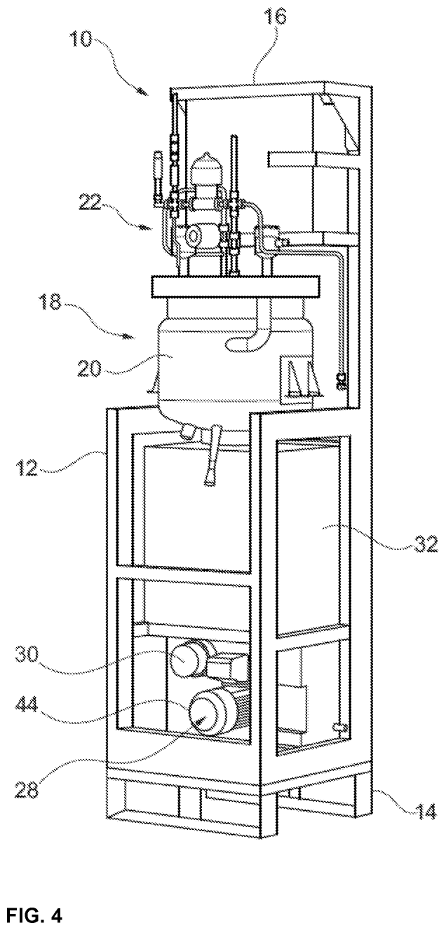

FIG. 4: the complete metering module in rear view.

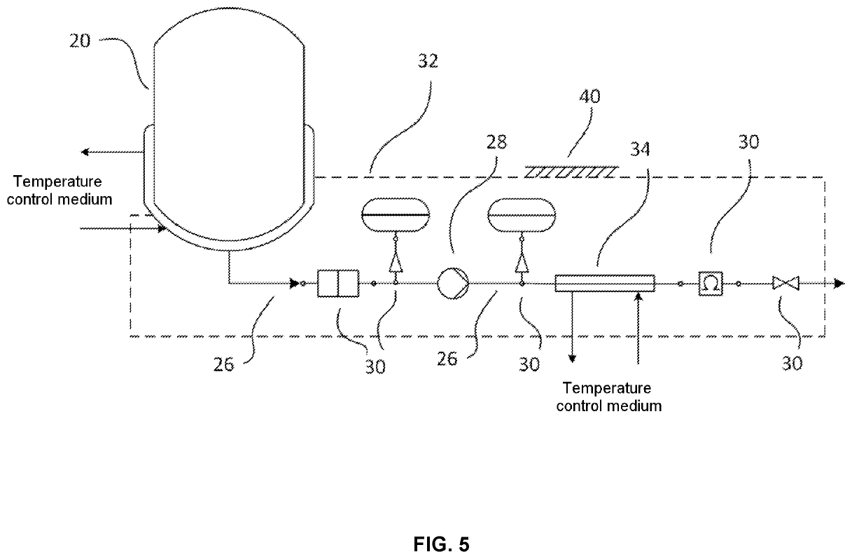

FIG. 5: the flow diagram for the metering module

FIG. 1 shows a working example of a metering module 10 for a process plant having a modular construction. The metering module comprises a frame 12 on or in which the further components of the module 10 are mounted. The frame 12 itself is arranged on a pallet 14. The further components of the metering module can be classified as follows: an electronics unit 16 which is configured as remote I/O controller and is arranged in the upper region of the frame 12, a pressure vessel unit 18 having a pressure vessel 20 and corresponding periphery 22, where the pressure vessel 20 is arranged below and the periphery is arranged next to the electronics unit 16, and a metering system (a metering assembly) 24 in a lower region of the module 10. The metering system 24 comprises a piping system 26 with various pipes, a pump 28 connected in the piping system 26 and other system components 30 of the metering system 24, for instance filters, shutoff valves, pressure measuring devices, a temperature measuring device, a flow meter and a relief valve to a waste conduit, but this will not be discussed in detail here and is therefore summarized under the reference numeral 30.

The metering module 10 additionally has a housing 32 which at least partly accommodates the metering system 24 and also a temperature control device configured as plate heat exchanger 34 for controlling the temperature of the interior of the housing 32. The electronics unit 16 configured as remote I/O controller is an instrument for remote access and for switching over distances via a network connection (e.g. Ethernet or Internet connection). The temperature control device is, inter alia, controlled or regulated via this electronics unit 16. The heating/cooling of the temperature control device configured as plate heat exchanger 34 is preferably effected by a separate, external temperature control apparatus (not depicted in the figure). The electronics unit 16 can preferably also control or regulate this separate, external temperature control apparatus.

FIG. 2 shows the individual components of the housing 32 and also a central component of the plate heat exchanger 34 configured as HEP system, namely a heat exchanger plate 36 of this HEP system. The heat exchanger plate 36 is arranged so that it forms or partly forms a wall of the housing 32. In addition to this heat exchanger plate 36, the housing 32 further comprises housing parts 38 and elements 40 for thermal insulation (also referred to as heat insulation).

FIGS. 3 and 4 now show the complete metering module 10. FIG. 3 shows a front view looking towards an open door 42 of the housing 32 and FIG. 4 shows a view of the rear side, in which it can be seen that parts of the pump 28, namely the pump drive 44, and parts of the flow meter 30 project from the housing 32. The corresponding housing wall has openings for this purpose. This wall is otherwise the part of the housing 32 which is (partly) formed by the heat exchanger plate 36.

The flow diagram in FIG. 5 likewise shows a working example of a metering module 10 for a process plant having a modular construction. This figure depicts, inter alia, a pressure vessel unit 18 having a pressure vessel 20, the metering system 24 consisting of piping system 26 with various pipes, a pump 28 connected in the piping system 26 and other system components 30 of the metering system 24, for instance filters, shutoff valves, pressure measuring devices, a temperature measuring device, a flow meter and a relief valve to a waste conduit.

The transition of the process fluid into the heated space of the module is depicted below the pressure vessel unit 18. The heating/cooling of the heat exchanger plate 36 is advantageously effected via an external temperature control apparatus which can be controlled or regulated via the electronics unit 16 configured as remote I/O controller.

The various aspects of the invention and also the advantages thereof will be described once more below:

The metering system 24, generally consisting of pump 28, pipes 26, filters, flow meter, valves and sensors 30, is constructed as a compact arrangement and, at least mostly, arranged in the housing 32 which can be/is delimited from the surroundings. At least one wall of the housing 32 is configured as temperature-controllable heat exchanger plate 36 which withdraws or supplies energy from or to the interior of the housing 32, which energy is introduced or removed by heat exchange with the surroundings or with attached components. The walls of the housing 32 are advantageously provided with heat insulation 40.

The temperature of the process fluid can be measured by sensors in the pipes 26 and employed for regulating the temperature of the temperature control medium for the temperature control device configured as plate heat exchanger 34.

The desired temperature in the housing 32 can also be measured and concomitantly employed for regulating the temperature of the temperature control medium for the temperature control device configured as plate heat exchanger 34.

The proposed temperature-controlled metering system 24 with housing follows the rationale of keeping the temperature of the components 26, 28, 30 to be maintained at temperature as far as possible in the enclosed region at such a level that the desired temperature of the process fluid is kept within prescribed limits and as far as possible dispensing with separate temperature control of the individual components. This allows a space-saving modular construction and effective temperature control.

For use in explosion hazard regions, making the housing parts of a conductive material (e.g. metal sheets) which can be fastened (e.g. screwed) to the frame 12 is proposed. The housing parts 38 configured as metal sheets can be coated on the inside of the housing with the elements 40 for heat insulation (e.g. by adhesive bonding), and it is likewise possible to use composite materials.

Since the pump drives 44, i.e. the drive motors, of conventional pumps 28 are generally not designed for use at high temperatures, an arrangement of the pump 28 which is such that the pump head is located in the temperature-controlled housing 32 and the motor is arranged outside is proposed. In order to assist conduction of heat from the heat exchanger plate 36 into the pump head, a particularly advantageous arrangement is attachment of the pump 28 directly to the heat exchanger plate 36 via the flange of the pump head.

Since the evaluation electronics of flow meters 30 are generally also not designed for use at high temperatures, an arrangement in which the electronics are also located outside the temperature-controlled housing 32 is proposed. In order to assist conduction of heat from the heat exchanger plate 36 into the fluid-conducting part of the flow meter 30, a particularly advantageous arrangement is installation on the outside of the heat exchanger plate 36.

As regards the sensors and actuators, preference is to be given to those which are approved for the temperature range within the region enclosed by the housing 32. If not, the liquid-conducting parts of the sensors and actuators should be arranged within the temperature-controlled housing 32 and the evaluation and control components should be arranged outside.

As plate structure 36, it can be advantageous to use a heat exchanger plate 36 of a flat-construction HEP system, e.g. from LOB GmbH, Cologne, which allows introduction of holes for fastening pump heads and other components to be heated/cooled directly to the heat exchanger plate 36.

1. Metering module, optionally for a process plant having a modular construction, having a metering system for metering a fluid, a housing which at least partly accommodates the metering system and also a temperature control device for controlling the temperature of the interior of the housing, wherein the temperature control device has a plate heat exchanger and at least part of the housing is formed by at least one plate structure of this plate heat exchanger, optionally by at least one heat exchanger plate.

2. Module according to claim 1, wherein the metering system has a plurality of system components which are fluidically connected to one another via a piping system.

3. Module according to claim 2, wherein at least one system components of the metering system is fastened directly to the or to at least one of the plate structures of the plate heat exchanger which form the part of the housing.

4. Module according to claim 2, wherein at least a part of the pipes of the piping system is configured as media-temperature-controllable pipes and/or at least one of the system components is media-temperature-controllable.

5. Module according to claim 2, wherein the system components of the metering system comprise at least one of the following components: a pump, a filter, a shutoff valve, a pressure measuring device, a temperature measuring device, a flow meter and a relief valve.

6. Module according to claim 1, wherein the metering module has the following further components for forming the housing in addition to the plate structure of the plate heat exchanger: a frame, housing parts and elements for thermal insulation.

7. Module according to claim 1, wherein the module further comprises a pressure vessel.

8. Module according to claim 1, wherein the module further comprises an electronics unit, optionally an electronics unit referred to as remote I/O controller.

9. Process plant having a modular construction for the production of a chemical and/or pharmaceutical product having a plurality of modules, wherein at least one of the modules is configured as metering module according to claim 1.

10. Method for controlling the temperature of a metering system for metering fluids within a metering module, comprising: a) providing a metering module comprising a metering system which is at least partly accommodated by a housing, where at least part of the housing is formed by at least one plate structure of a plate heat exchanger which controls the temperature of the interior of the housing; b) providing a temperature control medium for controlling the temperature of the plate heat exchanger, which medium is present in a circuit with the mete ring system; c) heating/cooling of the temperature control medium.
